(19) United States
(12) Patent Application Publication
(10) Pub. No.: US 2011/0078042 A1
(43) Pub. Date: Mar. 31, 2011

(54) SYSTEM AND METHOD FOR FACILITATING ELECTRONIC COMMERCE WITH CONTROLLED SPENDING OVER A NETWORK

(75) Inventor: Charles Fletcher, Los Gatos, CA (US)

(73) Assignee: eBay Inc., San Jose, CA (US)

(21) Appl. No.: 12/568,989

(22) Filed: Sep. 29, 2009

(51) Int. Cl. G06Q 30/00; G06Q 20/00; G06Q 50/00

(52) U.S. Cl. 705/26.35; 705/44

(57) ABSTRACT

In accordance with embodiments of the present disclosure, systems and methods for facilitating electronic commerce over a network include receiving a transaction request from a merchant on behalf of a client, accessing a client account associated with the client based on information passed with the transaction request, reviewing spending parameters stored as part of the client account, the spending parameters indicating acceptable merchant category codes for client approved merchants, comparing a merchant category code for the merchant with the acceptable merchant category codes of the spending parameters, approving the transaction request between the merchant and the client if the merchant category code for the merchant is determined to be an acceptable merchant category code of the spending parameters, and denying the transaction request between the merchant and the client if the merchant category code for the merchant is determined to be an unacceptable merchant category code of the spending parameters.

### BACKGROUND

1. Technical Field

The present invention generally relates to network transactions and, more particularly, to facilitating electronic commerce with controlled spending over a network.

2. Related Art

In electronic commerce, a client typically shops merchant sites, makes purchases, and pays for products through electronic communications with online service providers over communication networks, such as the Internet. During the course of shopping for products, the client typically provides payment in exchange for products from a merchant. Payment options include, for example, debit cards, credit cards, and electronic fund transfers.

In general, conventional card issuers typically allow an authorized card holder to make unrestricted purchases with an issued payment card from any authorized merchant without concern for the product being purchased. In some instances, the card holder may authorize other users to make purchases with the issued payment card. As such, the other authorized card users for the issued payment card may also make unrestricted purchases from any authorized merchant without concern for the product being purchased.

Sometimes, the other authorized users may make purchases with the issued payment card that the originally authorized card holder does not want them to make. Unfortunately, conventional card issuers do not allow for any purchase control for the issued payment card, which can be inconvenient for the originally authorized card holder. Accordingly, there exists a need to allow for discretionary control of spending with issued payment cards.

### SUMMARY

In accordance with embodiments of the present disclosure, systems and methods for facilitating electronic commerce over a network include receiving a transaction request from a merchant on behalf of a client, accessing a client account associated with the client based on information passed with the transaction request, reviewing spending parameters stored as part of the client account, the spending parameters indicating acceptable merchant category codes for client approved merchants, comparing a merchant category code for the merchant with the acceptable merchant category codes of the spending parameters, approving the transaction request between the merchant and the client if the merchant category code for the merchant is determined to be an acceptable merchant category code of the spending parameters, and denying the transaction request between the merchant and the client if the merchant category code for the merchant is determined to be an unacceptable merchant category code of the spending parameters.

In various implementations, the systems and methods may include establishing the client account with the client, receiving monetary funds from the client for deposit into the client account, configuring the spending parameters based on input from the client, issuing a payment media to the client, and allowing the client to use the payment media to make transaction requests. The transaction request may be initiated by the client with use of the payment media, and the merchant may receive the payment media from the client as a form of payment. The merchant may provide one or more items, products and/or services for purchase to the client, and the merchant may use a transaction device that allows the client to purchase the one or more items, products and/or services with the payment media. The client account may include some type of monetary deposit account (e.g., checking account, debit account, credit account, etc.), and the payment media may include a some form of debit card linked to the monetary deposit account.

In various implementations, the systems and methods may include maintaining a plurality of accounts including the client account and a merchant account related to the merchant. The client account may include financial information related to the client, and the merchant account may include financial information related to the merchant. The systems and methods may include storing information related to the client as part of the client account including the spending parameters. The systems and methods may include notifying the merchant if the transaction request is approved and notifying the merchant if the transaction request is denied. The systems and methods may include notifying the merchant if the merchant category code for the merchant is indicated as acceptable by the client and notifying the merchant if the merchant category code for the merchant is indicated as unacceptable by the client. An unacceptable merchant category code for the merchant may include at least one of adult, gaming, and gambling.

In accordance with embodiments of the present disclosure, a system for facilitating electronic commerce over a network may include a first component adapted to receive a transaction request from a merchant on behalf of a client and a second component adapted to process the transaction request. In one implementation, the second component comprises a processing component adapted to access a client account associated with the client based on information passed with the transaction request, review spending parameters stored as part of the client account, the spending parameters indicating acceptable merchant category codes for client approved merchants, compare a merchant category code for the merchant with the acceptable merchant category codes of the spending parameters, approve the transaction request between the merchant and the client if the merchant category code for the merchant is determined to be an acceptable merchant category code of the spending parameters, and deny the transaction request between the merchant and the client if the merchant category code for the merchant is determined to be an unacceptable merchant category code of the spending parameters. In another implementation, the processing component may be adapted to establish the client account with the client, receive monetary funds from the client for deposit into the client account, configure the spending parameters based on input from the client, issue a payment media to the client, and allow the client to use the payment media to make transaction requests.

These and other features and advantages of the present invention will be more readily apparent from the detailed description of the embodiments set forth below taken in conjunction with the accompanying drawings.

### BRIEF DESCRIPTION OF THE FIGURES

FIGS. 1A-1B show block diagrams of various systems for facilitating electronic commerce with controlled spending over a network, in accordance with embodiments of the present invention.

FIGS. 2A-2B show various methods for facilitating a client-side process to control spending in electronic commerce over a network, in accordance with embodiments of the present disclosure.

FIGS. 3A-3B show various methods for facilitating a service provider process to control spending in electronic commerce over a network, in accordance with embodiments of the present disclosure.

FIG. 4 shows a block diagram of a computer system suitable for implementing embodiments of the present invention.

Embodiments of the invention and their advantages are best understood by referring to the detailed description that follows. It should be appreciated that like reference numerals are used to identify like elements illustrated in one or more of the figures, wherein showings therein are for purposes of illustrating embodiments of the invention and not for purposes of limiting the same.

### DETAILED DESCRIPTION

Embodiments of the present disclosure provide systems and methods for facilitating electronic commerce with controlled spending over a network. In one embodiment, payment media (e.g., a debit card or a credit card) is adapted to utilize one or more existing networks (e.g., electronic debit and/or credit networks) and to allow for user-level configuration of allowable spending categories. In one implementation, a client may request a payment card, which may be referred to as a control card, that may be configured to allow or disallow purchases from one or more specific merchant category codes (MCCs). The control card may be configured to trigger alerts when purchases are made to various MCCs. For example, a short message service (SMS) alert may be sent to the cardholder when a purchase is made corresponding to a “gaming”, “gambling”, and/or “adult” MCC. As such, cardholders are able to configure allowable purchase categories at their discretion, and some specific use cases may benefit from a discretionary level of control. In various examples, employers may restrict use of company cards for employees to approved merchants, and parents may restrict use of spending cards for children to certain acceptable merchant categories.

Accordingly, a user-configurable control card, as described in reference to the present disclosure, provides discretionary control of purchases to allow or disallow purchases within certain categories of use, restrict purchases to specific merchants, and influence behavior of purchasers upon attempted purchases.

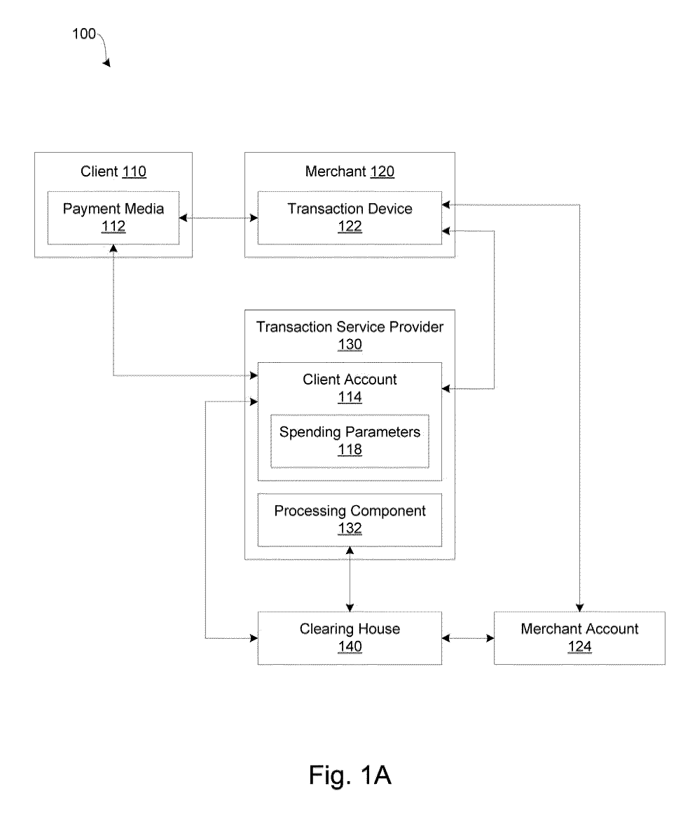

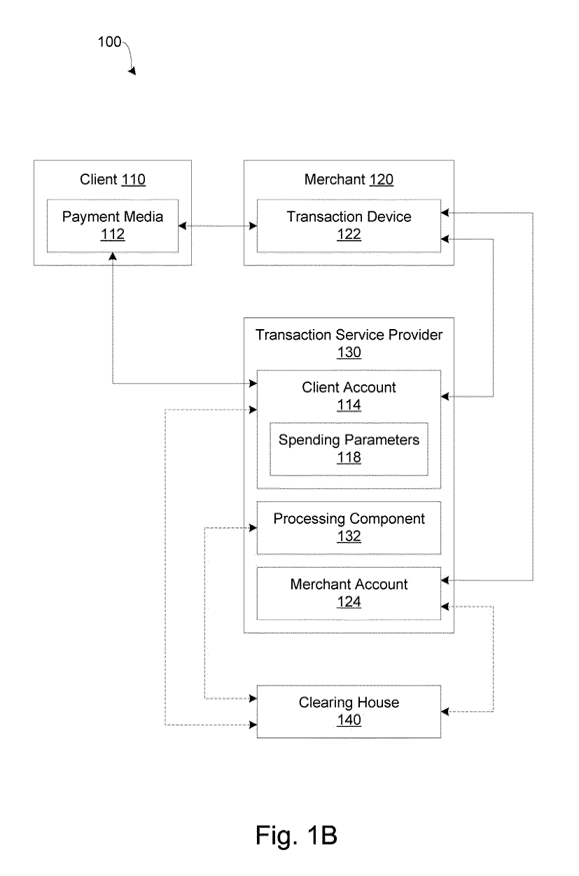

FIG. 1A shows one embodiment of a system 100 for facilitating electronic commerce with controlled spending over a network. As shown in FIG. 1A, the system 100 includes a client 110 that provides a form of monetary payment in exchange for a product and/or service, a merchant 120 that provides a product and/or service in exchange for monetary payment from the client 110, and a transaction service provider 130 that processes the transaction between the client 110 and the merchant 120. It should be appreciated that the merchant 120 may comprise a plurality of merchants with each having a transaction device 122 and an assigned merchant category code (MCC). It should also be appreciated that the client 110 may be referred to as a user or customer without departing from the scope of the present disclosure.

In one embodiment; the client 110 establishes a client account 114 with the transaction service provider 130, wherein the client 110 may deposit monetary funds in the client account 114. The transaction service provider 130 issues the client 110 some form of payment media 112, such as a electronic check resource, credit card, or debit card, that is linked to the client account 114. The client 110 may use the payment media 112 to purchase products and/or services from the merchant 120. The client 110 may establish the client account 114 with the transaction service provider 130, and the client 110 may link other accounts, such as a bank account, credit account, etc., with the client account 114. As such, the client 110 may provide identification information to the transaction service provider 130, such as a user name, password, photograph image, biometric id, address, phone number, etc., and banking information, such as a banking institution, credit card issuer, user account numbers, security information, etc.

In one embodiment, the client 110 is able to access the client account 114 and configure one or more spending parameters 118. For example, the client 110 may access the transaction service provider 130 via a communication network connection, such as an Internet link, mobile phone link, landline link, etc., and configure the spending parameters 118 via a user interface, such as a web browser or various application software. In another example, the client 110 may confer with an agent related to the transaction service provider 130 to configure the spending parameters 118.

In various implementations, the spending parameters 118 may be configured by the client 110 to allow or disallow purchases from one or more specific merchant category codes (MCCs). The spending parameters 118 may be configured by the client 110 to trigger one or more alerts when purchases are made to various MCCs. For example, a text message alert may be sent to a mobile phone of the client 110 when a purchase is made corresponding to a “gaming”, “gambling”, or “adult” MCC. As such, the client 110 may configure one or more allowable purchase categories at their discretion, and some specific use cases may benefit from this discretionary level of control configured by the client 110. In one example, employers may restrict use of company provided cards for employees to approved merchant category codes, and in another example, parents may restrict use of spending cards for children to certain acceptable merchant code categories.

Accordingly, the spending parameters 118 provide the client 110 with exclusive discretionary control of purchases to restrict purchases within particular categories of use, restrict purchases to specific merchants, and influence behavior of purchasers upon attempted purchases. In one particular example, a parent may not allow children to make purchases in certain MCCs (e.g., adult, gaming, gambling, airlines, etc.), and the parent may prefer to retain control to decide which categories are inappropriate for children's spending. It should be appreciated that various other categories may also be considered inappropriate, such as narcotics, illicit drugs, drug paraphernalia, sexuality, pornography, obscenity, etc., without departing from the scope of the present disclosure.

Referring to FIG. 1A, the client 110 may use the payment media 112 to purchase products and services from the merchant 120. The merchant 120 uses a transaction device 122, such as point-of-sale (POS) device, to request processing of the transaction between the client 110 and the merchant 120 from the transaction service provider 130. A processing component 132 of the transaction service provider 130 communicates with a clearing house 140 to debit the client account 114 according to an amount specific in the payment and credit therewith a merchant account 124 linked to the merchant 120. In one implementation, upon receiving a transaction request from the merchant 120, the processing component 132 accesses the client account 114, reviews the spending parameters 118, and determines whether the purchase is approved based on the MCC assigned to the merchant 120. As such, if the MCC of the merchant 120 is approved by verification with the spending parameters 118, then the processing component 132 allows the transaction to be completed. Otherwise, if the MCC of the merchant 120 is not approved by verification with the spending parameters 118, then the processing component 132 denies or cancels the transaction. In the event of a denied or cancelled transaction, the processing component 132 may send a notice of a non-approved MCC as reason for the denied or cancelled transaction.

In one embodiment, when a transaction is approved and completed, the clearing house 140 resolves financial transactions through validation, delivery, and settlement. As such, the clearing house 140 may comprise an agency or institution having a system for settling indebtedness between members of that system through which accounts may be debited and/or credited of monetary funds.

In one embodiment, the merchant 120 may establish the merchant account 124 with any type of financial institution, such as a bank. However, in another embodiment, as shown in FIG. 1B, the merchant 120 may establish the merchant account 122 with the transaction service provider 130. As such, the merchant 120 may need to provide business information to the transaction service provider 130, such as business name, address, phone number, etc., and financial information, such as banking information, merchant account information, credit card information, payment processing information, etc.

In one implementation, the transaction service provider 130 may directly debit the client account 114 and directly credit the merchant account 124 because both of the accounts 114, 124 are established with the transaction service provider 130. Optionally, in another implementation, the transaction service provider 130 may still process the transaction through the clearing house even though both of the accounts 114, 124 are established with the transaction service provider 130.

In one embodiment, the transaction device 122 is utilized by the merchant 120 to accept payment from the client 110. The transaction device 122 comprises some form of payment device, such as, for example, a POS terminal, a cash register, a personal computer, etc. The transaction device 122 may comprise one or more functional components including a reader component, an input component, a processor component, a transceiver component, and an output component. The reader and input components may comprise a check reader, credit card reader, debit card reader, keyboard for manual input of account information, or some combination thereof for the purpose of acquiring transaction information from the client 110 at the point of sale. Once acquired, the transaction information may be transferred from the transaction device 122 of the merchant 120 to the processing component 132 of the transaction service provider 130 for processing.

In one implementation, the transaction may take place over a network, such as the Internet, a mobile communication network, a landline communication network, a satellite communication network. The payment media 112 of the client 110 may include a network interface device, such as a computer, mobile phone, personal digital assistant, etc., that is adapted to allow the client 110 to communicate with the merchant 120 and the transaction service provider 130 via the network. The transaction device 122 of the merchant 120 may include a server that is adapted to communicate with the client 110 to allow viewing and purchase of products and/or services via the network and further communicate with the transaction service provider 130 to process financial transactions via the network. Similarly, the processing component 132 of the transaction service provider 130 may include a server that is adapted to communicate with the client 110, the merchant 120 and the clearing house 140 to process and resolve financial transactions via the network.

In one embodiment, the network may be implemented as a single network or a combination of multiple networks. For example, in various embodiments, the network may include the Internet, one or more intranets, landline networks, wireless networks, and/or some other appropriate type of communication network. In another example, the network may comprise a wireless telecommunications network (e.g., cellular phone network) adapted to communicate with other communication networks, such as the Internet.

In one embodiment, the client 110 may use an interface device, such as a personal computer, mobile phone device, etc., to communicate with the merchant and/or access the client account 114 via any appropriate combination of hardware and/or software configured for wired and/or wireless communication over the network. In one implementation, the client 110 may use a browser application to browse information available over the network. For example, the client 110 may use a web browser to view information available over the Internet.

In one embodiment, the client 110 may be asked to provide identification information to the merchant 120 for transaction processing. For example, the identification information provided by the client 110 may include personal information (e.g., a user name, password, photograph image, biometric id, address, phone number, etc.) and banking information (e.g., banking institution, credit card issuer, user account numbers, security information, etc.). In various implementations, identification information provided by the client 110 may be passed with a purchase request to the processing component 132 of the transaction service provider 130 to associate the client 110 with the client account 114 and the spending parameters 118 maintained by the transaction service provider 130.

In one embodiment, the merchant 120 may maintain one or more merchant servers on the network for offering various products and/or services for purchase in exchange for payment to be received from the client 110 over the network. In this regard, each of the one or more merchant servers may include a database for identifying available products and/or services, which may be made available to the client 110 for viewing and purchase. Each of the merchant servers may include some form of a marketplace application software configured to provide information over the network to a browser application used by the client 110. For example, the client 110 may interact with the marketplace application through a browser application over the network to search and view various products and/or services for purchase identified in the database. Each of the one or more merchant servers may include some form of checkout application configured to facilitate online purchase transactions by the client 110 for products and/or services identified by the marketplace application. In this regard, the checkout application may be configured to accept payment information from the client 110 over the network.

In one embodiment, the merchant 120 may need to provide identification information to be included as part of the transaction request. The identification information may include business and banking information. In various implementations, the identification information provided by the merchant 120 may be passed with the transaction request to the processing component 132 of the transaction service provider 130 to process the transaction, and the identification information provided by the merchant 120 may be used by the processing component 132 to associate the transaction with the merchant account 124.

In one embodiment, the transaction service provider 130 provides transaction processing for point-of-sale or online purchases on behalf of the client 110 and the merchant 120. In this regard, the transaction service provider 130 may use some form of payment application configured to interact with the client 110 and the merchant 120 to facilitate the purchase of products and/or services. In one example, the transaction service provider 130 may be provided by PayPal, Inc. of San Jose, Calif., USA.

In one embodiment, the transaction service provider 130 may be configured to maintain a plurality of client and merchant accounts 114, 124, each of which may include account information associated with clients and merchants. For example, account information may include private financial information of the client 110 and merchant 120, such as one or more account numbers, passwords, credit card information, banking information, or other types of financial information, which may be used to facilitate transactions between the client 110 and the merchant 120.

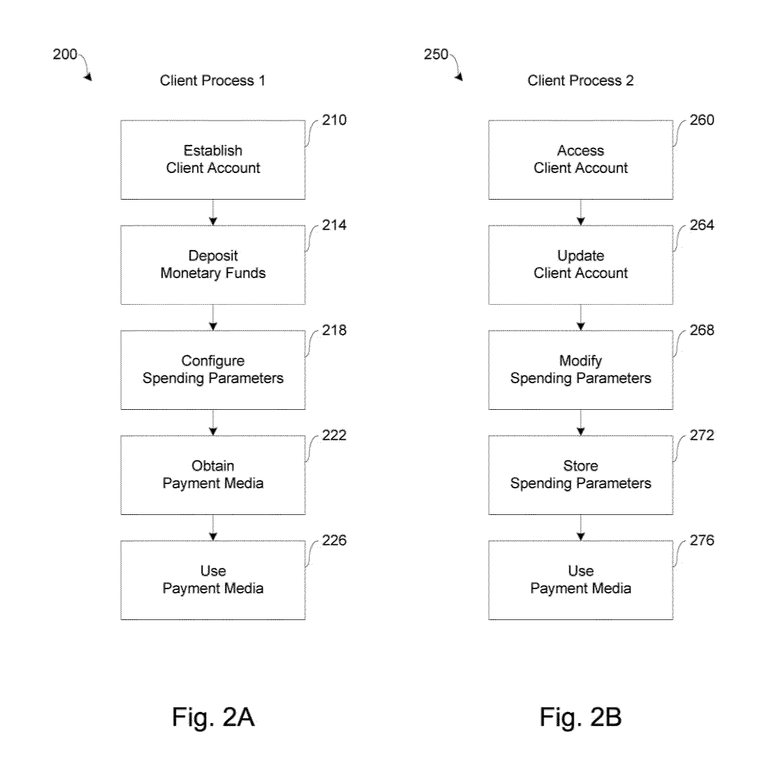

FIG. 2A shows one embodiment of a method 200 for facilitating a client-side process to control spending in electronic commerce over a network. For purposes of explanation, the method 200 is discussed in reference to FIGS. 1A-1B, but should not be limited thereto.

In one implementation, the client 110 establishes the client account 114 with the transaction service provider 130 (block 210). When establishing the client account 114, the client 110 may be prompted to provide personal identification information, such as a client name, password, photograph image, biometric id, address, phone number, etc., and financial information, such as banking information, credit information, account numbers, security information, etc. In one aspect, information related to the client 110 may be packaged as a client identifier, which may include attributes related to the client 110, such as personal information and banking information. In various aspects, the client identifier may be passed with a login request, access request, purchase request, and/or transaction request to the transaction service provider 130 via a network, and the client identifier may be used by the transaction service provider 130 to associate the client 110 with a particular client account, such as the client account 114, maintained by the transaction service provider 130, in a manner as described herein.

The client 110 deposits monetary funds in the client account 114 with the transaction service provider 130 (block 214). In one aspect, the client 110 may deposit cash monetary funds into the client account 114 by postal mail, electronic check, in person, etc. In another aspect, the client 110 may link other accounts, such as a bank account, credit account, etc., with the client account 114 to electronically transfer or deposit monetary funds into the client account 114. The client 110 may be prompted to provide identification information to the transaction service provider 130 and banking information prior to depositing monetary funds into the client account 114.

The client 110 configures the spending parameters 118 with the transaction service provider 130, which may be stored as part of the client account 114 (block 218). In one aspect, the client 110 is able to access the client account 114 and configure one or more of the spending parameters 118. For example, the client 110 may access the transaction service provider 130 via a communication network connection, such as an Internet link, mobile phone link, landline link, etc., and configure the spending parameters 118 via a user interface, such as a web browser or various application software. In another example, the client 110 may confer with an agent related to the transaction service provider 130 over a communication link, such as a mobile phone, to verbally configure the spending parameters 118. Once the spending parameters 118 are configured by the client 110, the transaction service provider 130 is adapted to approve or deny purchase transactions from particular merchants based on assigned merchant category codes (MCCs), as described herein.

The client 110 obtains the payment media 112 from the transaction service provider 130 (block 222). In one aspect, the transaction service provider 130 is adapted to issue the payment media 112 to the client 110 in the form of, for example, a debit card having an account number and expiration date associated therewith. In one example, the debit card may be sent to the client 110 via postal mail. In another aspect, the transaction service provider 130 may be adapted to issue an electronic debit card number and expiration date to the client 110 for use in electronic purchases over the network. In various aspects, it should be appreciated that the use of the debit card number may require a security pin number or code that allows authorization of purchases.

Once the payment media is obtained, the client 110 is permitted to use the payment media 112 to make purchases from a merchant, such as merchant 120 (block 226). With the issued payment media 112; the client 110 has the ability to purchase products and/or services from the merchant 120.

FIG. 2B shows one embodiment of a method 250 for facilitating a client-side process to control spending in electronic commerce over a network. For purposes of explanation, the method 250 is discussed in reference to FIGS. 1A-1B, but should not be limited thereto.

In one implementation, the client 110 may access the client account 114 with the transaction service provider 130 (block 260). In one aspect, the client 110 may access an established client account, such as client account 114, by providing personal identification information, such as a client name, password, etc., and/or financial information, such as account information, security information, etc. In another aspect, the client 110 may access the client account 114 by providing a client identifier, which may include attributes related to the client 110, such as personal information and banking information.

The client 110 may update information related to the client account 114 with the transaction service provider 130 (block 264). In one aspect, the client 110 may deposit or withdrawal monetary funds from the client account 114. These monetary funds may be transferred electronically or via check in postal mail. In another aspect, the client 110 may update personal information and/or banking information. For example, personal information, such as addresses, phone numbers, etc. may be periodically changed to reflect the present state of the client's residence. In another aspect, the client 110 may update links to other accounts, such as a bank account, credit account, etc., with the client account 114 to electronically transfer or deposit monetary funds into the client account 114.

The client 110 may modify the spending parameters 118 with the transaction service provider 130 (block 268), and the modified spending parameters 118 may be stored as part of the client account 114 (block 272). In one aspect, the client 110 is able to access the client account 114 and modify one or more of the spending parameters 118. For example, the client 110 may access the transaction service provider 130 via a communication network connection and modify the spending parameters 118 via a user interface application. In another example, the client 110 may confer with an agent related to the transaction service provider 130 over a communication link to verbally modify the spending parameters 118. Once the spending parameters 118 are modified by the client 110, the transaction service provider 130 is adapted to approve or deny purchase transactions from particular merchants based on assigned merchant category codes, as modified by the client 110.

Once the client account 114 is updated and/or the spending parameters 118 are modified and stored, the client 110 may use the payment media 112 to make purchases from a merchant, such as merchant 120 (block 276). In one aspect, the previously issued payment media 112 may be used since the spending parameters 118 are updated with the transaction service provider 130, and as such, the client 110 has the ability to purchase products and/or services from the merchant 120 with the modified spending parameters 118.

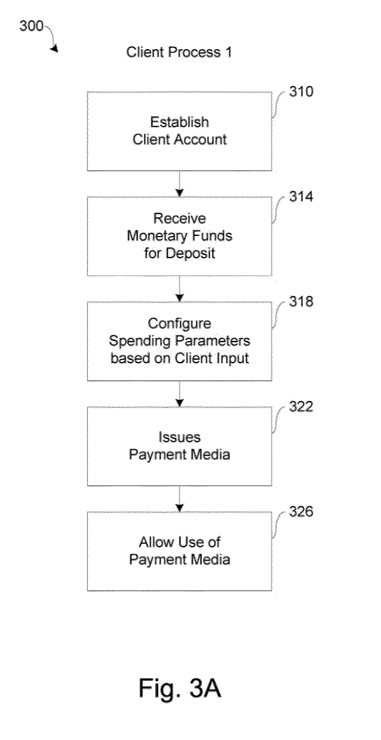

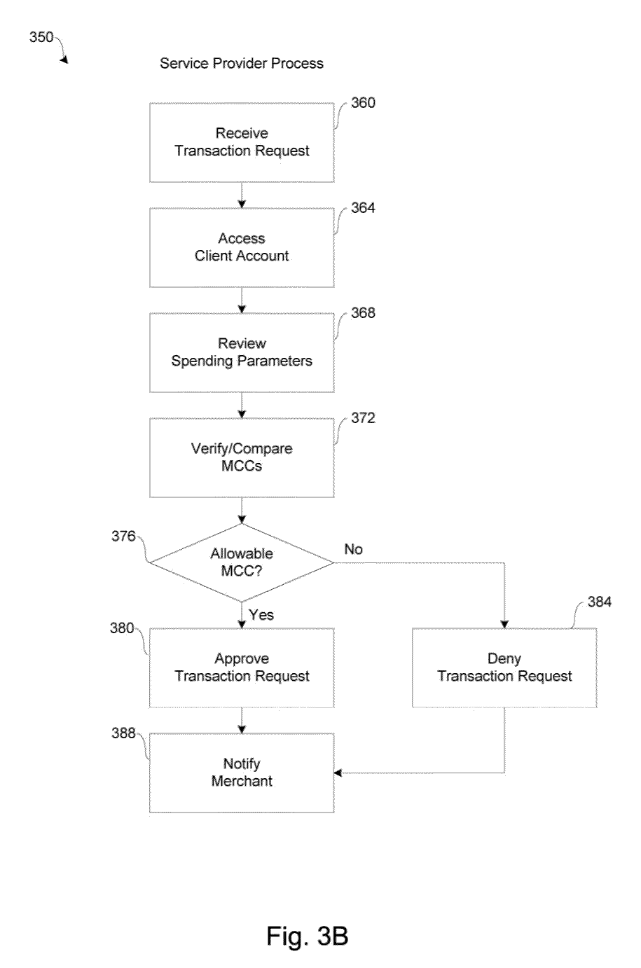

FIG. 3A shows one embodiment of a method 300 for facilitating a service provider process to control spending in electronic commerce over a network. For purposes of explanation, the method 300 is discussed in reference to FIGS. 1A-1B, but should not be limited thereto.

In one implementation, the transaction service provider 130 is adapted to establish a client account 114 with the client 110 based on information provided or inputted by the client (block 310). When establishing the client account 114 with the client 110, the transaction service provider 130 is adapted to prompt the client 110 to provide identification information, such as a client name, password, photograph image, biometric id, address, phone number, etc., and financial information, such as banking information, credit information, account numbers, security information, etc. In one aspect, information related to the client 110 may be stored as part of the client account 114 and may be packaged as a client identifier, which may include attributes associated with the client 110, such as personal information and banking information. In various aspects, the client identifier may be passed with the transaction request to the transaction service provider 130 via a network, and the client identifier may be used by the transaction service provider 130 to associate the client 110 with a particular client account; such as the client account 114, maintained by the transaction service provider 130, in a manner as described herein.

The transaction service provider 130 is adapted to receive monetary funds from the client 110 for deposit in the established client account 114 (block 314). In one aspect, the transaction service provider 130 is adapted to receive cash based monetary funds from the client 110 for deposit into the client account 114 by, e.g., postal mail, electronic check, in person, etc. in another aspect, the transaction service provider 130 is adapted to link other accounts, such as a bank account, credit account, etc., with the client account 114 to transfer or deposit monetary funds into the client account 114. The transaction service provider 130 may prompt the client 110 to provide permission to link other accounts to the client account 114 and to provide identification information to the transaction service provider 130 prior to depositing monetary funds into the client account 114.

The transaction service provider 130 is adapted to configure the spending parameters 118 based on information provided by or inputted from the client 110 (block 318). In one aspect, the transaction service provider 130 is adapted to prompt the client 110 to configure the spending parameters 118 for the client account 114 via a network connection, such as an Internet link, mobile phone link, landline link, etc. and set the spending parameters 118 via a user interface, such as a web browser or various application software. In another aspect, the client 110 may confer with an agent associated with the transaction service provider 130 over a communication link, such as a mobile phone, landline phone, etc., to verbally set the spending parameters 118. Once the spending parameters 118 are configured, the transaction service provider 130 is adapted to approve or deny purchase transactions from particular merchants based on assigned merchant category codes (MCCs), as described herein.

The transaction service provider 130 is adapted to issue the payment media 112 to the client 110 in the form of for example, a debit card having an account number and expiration date associated therewith (block 322). In one aspect, the transaction service provider 130 is adapted to generate and deliver the payment media 112 to the client 110 via postal mail. In another aspect, the transaction service provider 130 may be adapted to issue an electronic debit card number and expiration date to the client 110 for use in electronic purchases over the network. In various aspects, it should be appreciated that the use of the debit card number may require a security pin number or code that allows authorization of purchases.

The transaction service provider 130 is adapted to allow the client 110 to use the payment media to make purchases (block 326). With the issued payment media 112, the client 110 has the ability to purchase products and/or services from a merchant, such as merchant 120, over a network, such as the Internet, mobile phone network, etc.

FIG. 3B shows one embodiment of a method 350 for facilitating a service provider process to control spending in electronic commerce over a network. For purposes of explanation, the method 350 is discussed in reference to FIGS. 1A-1B, but should not be limited thereto.

In one implementation, the transaction service provider 130 is adapted to receive a transaction request (e.g., a purchase request) from a merchant, such as merchant 120, on behalf of the client 110 (block 360). In one aspect, the merchant 120 is adapted to send the transaction request to the transaction service provider 130 via a communication network, such as the Internet, mobile phone, etc. The transaction request includes information related to the client 110 including identification information, banking information, etc., information related to the products and/or services requested for purchase by the client 110, and information related to the merchant 120 including an assigned or associated MCC. This information passed with the transaction request allows the transaction service provider 120 to process the transaction request.

The transaction service provider 130 is adapted to locate and access the client account 114 (block 364) and review the spending parameters 118 (block 368) linked to or stored as part of the client account 114. In one aspect, the transaction service provider 130 stores information for the client account 114 and the spending parameters 118 associated therewith in a database for ease of access. The information passed with the transaction request allows the transaction service provider 120 to access the client account 114, review the spending parameters 118 associated therewith including allowable MCCs, review the merchant MCC, and continue processing the transaction request.

The transaction service provider 130 is adapted to verify and/or compare the MCC of the merchant 120 that provided the transaction request with the allowable MCCs listed by the spending parameters 118 of the client account 114 (block 372). In one aspect, the transaction service provider 130 obtains and verifies the assigned or associated MCC for the merchant 120 based on information passed with the transaction request, and then the transaction service provider 130 compares the MCC for the merchant 120 with the allowable MCCs listed as part of the spending parameters 118.

In one implementation, if the transaction service provider 130 determines that the MCC for the merchant 120 is allowable or acceptable by comparison with the spending parameters 118 (block 376), then the transaction service provider 130 is adapted to approve the transaction request (block 380). Then, the transaction service provider 130 is adapted to notify the merchant 120 that the transaction request is approved (block 388).

Otherwise, in another implementation, if the MCC for the merchant 120 is determined to be unallowable or unacceptable by comparison with the spending parameters 118 (block 376), then the transaction service provider 130 is adapted to deny the transaction request (block 384). Then, the transaction service provider 130 is adapted to notify the merchant 120 that the transaction request is denied (block 388).

In one embodiment, the spending parameters 118 allow for client configuration of allowable spending categories for a particular payment media. As such, in one aspect, the client 110 is able to set allowable purchase categories with the transaction service provider 130 at their discretion by configuring the spending parameters 118 to allow or disallow purchases from specific MCCs, and some specific use cases may benefit from a discretionary level of client based control. In various examples, employers may restrict use of company cards for employees to approved merchants, and parents may restrict use of spending cards for children to certain acceptable merchant categories. Therefore, the client configured spending parameters 118 provide discretionary control of purchases to allow or disallow purchases within certain categories of use, restrict purchases to specific merchants, and influence behavior of purchasers upon attempted purchases.

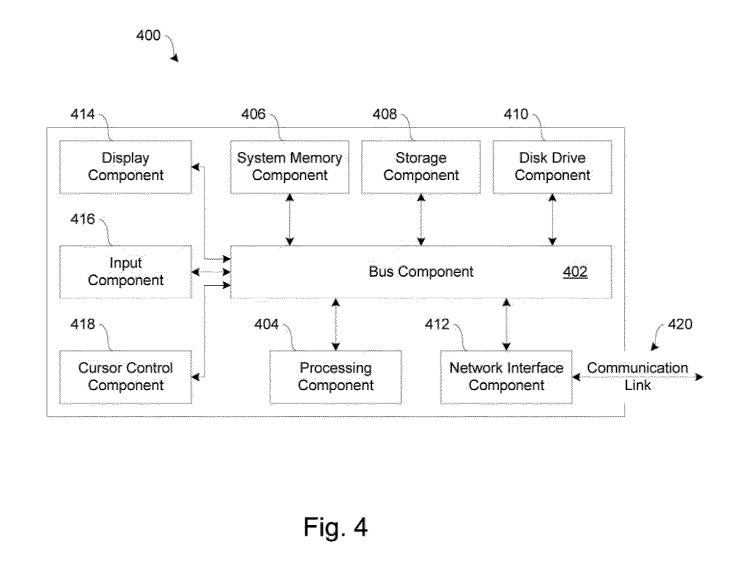

FIG. 4 shows a block diagram of a computer system 400 suitable for implementing embodiments of the present disclosure. Computer system 400 includes a bus 402 or other communication mechanism for communicating information, which interconnects subsystems and components, such as processing component 404 (e.g., processor, micro-processor, micro-controller, digital signal processing (DSP) device), system memory component 406 (e.g., RAM), static storage component 408 (e.g., ROM), disk drive component 410 (e.g., magnetic or optical), network interface component 412 (e.g., modem, Ethernet card, wireless transceiver), display component 414 (e.g., CRT or LCD), input component 416 (e.g., keyboard), and cursor control component 418 (e.g., mouse or trackball).

In accordance with embodiments of the present disclosure, computer system 400 performs specific operations by processor 404 executing one or more sequences of one or more instructions contained in system memory component 406. Such instructions may be read into system memory component 406 from another computer readable medium, such as static storage component 408 or disk drive component 410. In other embodiments, hard-wired circuitry may be used in place of or in combination with software instructions to implement embodiments of the present disclosure.

Logic may be encoded in a computer readable medium, which may refer to any medium that participates in providing instructions to processor 404 for execution. Such a medium may take many forms, including but not limited to, non-volatile media and volatile media. In various implementations, non-volatile media includes optical or magnetic disks, such as disk drive component 410, and volatile media includes dynamic memory, such as system memory component 406. It should be appreciated that data and information related to instructions may be transmitted to computer system 400 via various types of transmission media, such as coaxial cables, copper wire, and fiber optics, including wires that comprise bus 402. In various examples, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the invention may be performed by computer system 400. In various other embodiments of the present disclosure, a plurality of computer systems 400 coupled by communication link 420 (e.g., LAN, wireless LAN, wireless network) may perform instruction sequences to practice the invention in coordination with one another.

Computer system 400 may transmit and receive messages, data, information and instructions, including one or more programs (i.e., application code) through communication link 420 and network interface component 412. Received program code may be executed by processor 404 as received and/or stored in disk drive component 410 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure.

Having thus described embodiments of the invention, persons of ordinary skill in the art will recognize that changes may be made in form and detail without departing from the scope of the invention. Thus, the invention is limited only by the claims.

What is claimed is:

1. A method for facilitating electronic commerce over a network, the method comprising:
receiving a transaction request from a merchant on behalf of a client;
accessing a client account associated with the client based on information passed with the transaction request;
reviewing spending parameters stored as part of the client account, the spending parameters indicating acceptable merchant category codes for client approved merchants;
comparing a merchant category code for the merchant with the acceptable merchant category codes of the spending parameters;
approving the transaction request between the merchant and the client if the merchant category code for the merchant is determined to be an acceptable merchant category code of the spending parameters; and
denying the transaction request between the merchant and the client if the merchant category code for the merchant is determined to be an unacceptable merchant category code of the spending parameters.

2. The method of claim 1, further comprising:
establishing the client account with the client;
receiving monetary funds from the client for deposit into the client account;
configuring the spending parameters based on input from the client;
issuing a payment media to the client; and
allowing the client to use the payment media to make transaction requests.

3. The method of claim 2, wherein the transaction request is initiated by the client with use of the payment media, and wherein the merchant receives the payment media from the client as a form of payment.

4. The method of claim 2, wherein the merchant provides one or more items for purchase to the client, and wherein the merchant comprises a transaction device that allows the client to purchase the one or more items with the payment media.

5. The method of claim 2, wherein the client account comprises a checking account, and wherein the payment media comprises a debit card linked to the checking account.

6. The method of claim 1, further comprising maintaining a plurality of accounts including the client account and a merchant account related to the merchant, wherein the client account includes financial information related to the client, and wherein the merchant account includes financial information related to the merchant.

7. The method of claim 1, further comprising storing information related to the client as part of the client account including the spending parameters.

8. The method of claim 1, further comprising:
notifying the merchant if the transaction request is approved; and
notifying the merchant if the transaction request is denied.

9. The method of claim 1, further comprising:
notifying the merchant if the merchant category code for the merchant is indicated as acceptable by the client; and
notifying the merchant if the merchant category code for the merchant is indicated as unacceptable by the client.

10. The method of claim 1, wherein an unacceptable merchant category code for the merchant comprises at least one of adult, gaming, and gambling.

11. A system for facilitating electronic commerce over a network, the system comprising:
a first component adapted to receive a transaction request from a merchant on behalf of a client;
a second component adapted to:
access a client account associated with the client based on information passed with the transaction request;
review spending parameters stored as part of the client account, the spending parameters indicating acceptable merchant category codes for client approved merchants;
compare a merchant category code for the merchant with the acceptable merchant category codes of the spending parameters;
approve the transaction request between the merchant and the client if the merchant category code for the merchant is determined to be an acceptable merchant category code of the spending parameters; and
deny the transaction request between the merchant and the client if the merchant category code for the merchant is determined to be an unacceptable merchant category code of the spending parameters.

12. The system of claim 11, the second component further adapted to:
establish the client account with the client;
receive monetary funds from the client for deposit into the client account;
configure the spending parameters based on input from the client;
issue a payment media to the client; and
allow the client to use the payment media to make transaction requests.

13. The system of claim 12, wherein the transaction request is initiated by the client with use of the payment media, and wherein the merchant receives the payment media from the client as a form of payment.

14. The system of claim 12, wherein the merchant provides one or more items for purchase to the client, and wherein the merchant comprises a transaction device that allows the client to purchase the one or more items with the payment media.

15. The system of claim 12, wherein the client account comprises a checking account, and wherein the payment media comprises a debit card linked to the checking account.

16. The system of claim 11, the second component further adapted to:
maintain a plurality of accounts including the client account and a merchant account related to the merchant,
wherein the client account includes financial information related to the client, and
wherein the merchant account includes financial information related to the merchant.

17. The system of claim 11, further comprising a third component adapted to store information related to the client as part of the client account including the spending parameters.

18. The system of claim 11, the second component further adapted to:
notify the merchant if the transaction request is approved; and
notify the merchant if the transaction request is denied.

19. The system of claim 11, the second component further adapted to:
notify the merchant if the merchant category code for the merchant is indicated as acceptable by the client: and
notify the merchant if the merchant category code for the merchant is indicated as unacceptable by the client.

20. The system of claim 11, wherein an unacceptable merchant category code for the merchant comprises at least one of adult, gaming, and gambling.

21. Software encoded in at least one computer readable medium and when executed operable to:
receive a transaction request from a merchant on behalf of a client;
access a client account associated with the client based on information passed with the transaction request;
review spending parameters stored as part of the client account, the spending parameters indicating acceptable merchant category codes for client approved merchants;
compare a merchant category code for the merchant with the acceptable merchant category codes of the spending parameters:
approve the transaction request between the merchant and the client if the merchant category code for the merchant is determined to be an acceptable merchant category code of the spending parameters; and
deny the transaction request between the merchant and the client if the merchant category code for the merchant is determined to be an unacceptable merchant category code of the spending parameters.

22. The software of claim 21, further operable to:
establish the client account with the client;
receive monetary funds from the client for deposit into the client account;
configure the spending parameters based on input from the client;
issue a payment media to the client; and
allow the client to use the payment media to make transaction requests.
